(19) United States
(12) Patent Application Publication
(10) Pub. No.: US 2010/0324978 A1
(43) Pub. Date: Dec. 23, 2010

(54) METHOD AND APPARATUS FOR PROVIDING INCENTIVES TO PURCHASERS

(76) Inventors: William Gibbens Redmann, Glendale, CA (US); Robert Levy, Princeton, NJ (US); Mark Leroy Walker, Castaic, CA (US)

Correspondence Address: Robert D. Shedd, Patent Operations;THOMSON Licensing LLC, P.O. Box 5312, Princeton, NJ, 08543-5312, US

(21) Appl. No.: 12/736,011

(22) PCT Filed: Mar. 7, 2008
(86) PCT No.: PCT/US08/03021

§ 371 Date: Sep. 1, 2010

(51) Int. Cl. G06Q 30/00; G06Q 90/00; G06F 17/30

(52) U.S. Cl. 705/14.1; 705/500; 705/14.49; 707/769; 707/E17.014

(57) ABSTRACT

A pre-sale offer system (150) can advantageously provide a consumer (209, 234) who has selected an item for purchase with a pre-sale offer corresponding to the selected item to influence the consumer's buying decision. A pre-sale offer can constitute an incentive to buy a competing item. Alternatively, the pre-sale offer could constitute an advertisement or other promotional material that would reinforce the decision to buy the identified item. Further, the pre sale offer could include an advertisement, a coupon or other promotional material for one or more companion items, for example incremental ingredients that complete a recipe associated with the identified item.

### TECHNICAL FIELD

This invention relates to a technique for offering incentives to consumers to influence buying decisions.

### BACKGROUND ART

Many factors influence consumer purchasing decisions. The price of the item being purchased usually constitutes a prime factor in the purchasing decision. Many times, a consumer will seek the lowest price, to the exclusion of any other consideration. Brand reputation also can influence purchasing decision. Some consumers often prefer name-brand goods or services, hereinafter referred to collectively, as “items”, even if a lower-priced alternative exists. Such consumers believe that the reputation of the manufacturer assures higher quality and/or a better value.

While some consumers will decide in advance what item(s) to purchase, other consumers make purchasing decisions on the spot. Thus, such consumers remain susceptible to point-of-purchase advertising and especially point-of purchase advertising that offers an incentive in the form of a price discount. Occasionally, manufacturers who distribute items in a supermarket or a department store will provide a coupon dispenser adjacent to the shelf carrying the corresponding item, thus providing the consumer an incentive to select that item for purchase. This approach works well, provided the consumer becomes aware of the coupon dispenser. If the consumer has already purchased a competing item from a different location in the store, the consumer likely will not take account of the coupon dispenser and purchase the advertised item.

Retailers also make use of other techniques to entice consumers to purchase certain items. Many supermarket and department stores now employ systems to play free-running advertisements on displays adjacent to point-of-sale terminals (e.g., cash registers). In addition to, or in place of such free-running advertisements, many stores now have a coupon printer linked to the point-of-sale terminal for printing post-sale offers, such as advertisements, and particularly discount coupons. In some instances, the post-sale offers do not bear any particular relationship with the items selected by the consumer. For example, the post-sale offers might target certain items on sale, (e.g., “specials”) and/or seasonal items. In other words, the printer will print a one or more selected post-sale offers regardless of what the consumer purchases. In addition to providing to providing such “general” post sale offers, the coupon printer can print post-sale offers to target certain items goods already purchased to influence future buying decisions.

These approaches have marginal effectiveness at influencing a consumer's decision make a present purchase. Thus, a need exists for a technique that can significantly influence present buying decisions.

### BRIEF SUMMARY OF THE INVENTION

Briefly, in accordance with a preferred embodiment of the present principles, there is provided a method for providing a pre-sale offer to a consumer prior to the actual purchase of an item to influence the purchasing decision. The method comprises the step of identifying at least one selected item prior to a purchase transaction. In practice, such identification occurs by reading a bar code or detecting a Radio Frequency Identification (RFID) associated with the at least one selected item. Thereafter, at least one pre-sale offer is provided prior to the purchase of the at least one identified item.

A pre-sale offer can constitute an incentive to buy a competing item. Alternatively, the pre-sale offer could constitute an advertisement or other promotional material that would reinforce the decision to buy the identified item. Further, the pre-sale offer could include an advertisement, a coupon or other promotional material for one or more companion items, for example incremental ingredients that complete a recipe associated with the identified item. In this way, the pre-sale offer can motivate the consumer to buy either the originally selected item or a competing item, and/or to buy one or more companion items

In practice, the step of providing the at least one pre-sale offer includes the step of accessing a database of pre-sale offers indexed by item identifiers. If a pre-sale offer exists for the at least one identified item, the pre-sale offer is provided to the consumer prior to the purchase, such as by a multimedia presentation and/or printed material.

Under circumstances where a consumer has selected multiple items prior to purchase, multiple pre-sale offers can exist. Such pre-sale offers can be prioritized in a variety of ways to provide the consumer with such pre-sale offers in priority order.

### BRIEF DESCRIPTION OF THE DRAWINGS

FIG. 1 depicts a block schematic diagram of a Point-of-Sale (POS) system including a checkout coupon printer in accordance with the prior art;

FIG. 2 depicts a block schematic diagram of a pre-sale offer system for influencing a present purchase transaction in accordance with a preferred embodiment of the present principles.

FIG. 3 shows a perspective view of a checkout stand that embodies the POS system of FIG. 1 and the pre-sale offer system of FIG. 2;

FIG. 4 depicts a flowchart of a process practiced by the pre-sale offer system of FIG. 2 for detecting an item and checking the existence of pre-sale offer(s) associated with that item; and

FIG. 5 depicts a flow chart of a process practiced by the pre-sale offer system of FIG. 2 for presenting the pre-sale offers detected during the process of FIG. 4 to a consumer to influence a present purchasing decision.

### DETAILED DESCRIPTION

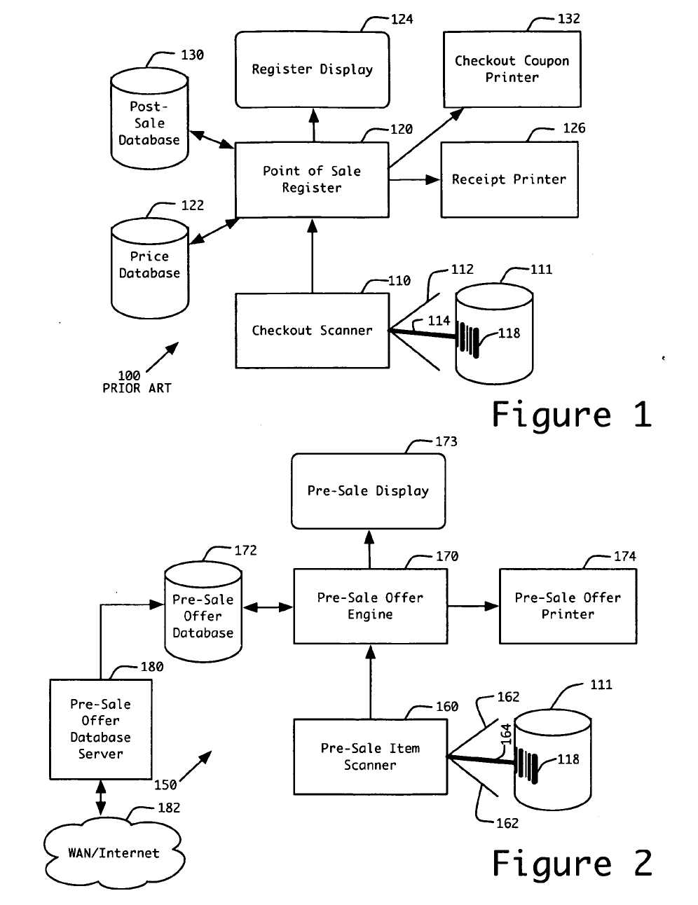

FIG. 1 depicts a block schematic diagram of a point-of-sale system 100, some times referred to as a checkout register, known in the prior art. The point-of-sale system 100 comprises a checkout scanner 110 suitable for identifying an item 111 as it comes within the scanner's field-of-view (FOV) 112. As discussed hereinafter, the checkout scanner 110 can also scan discount coupons (not shown), as are well known in the art. The checkout scanner 110 typically comprises a barcode reader (not shown) that emits an interrogation beam 114 for reading a barcode 118 on the item 111. In practice, a laser (not shown) within the checkout scanner 110 emits a beam 114 to sweep the scanner's FOV 112. To read the barcode 118, the checkout scanner 110 monitors modulation of the backscattering of the beam 114 upon striking the barcode 118. In this way, the checkout scanner 110 obtains information, in the form of numeric data that identifies the item 111. Rather than carry the bar code 118, the item 111 could carry a Radio Frequency Identification (RFID) tag or the like. Under such circumstances, the checkout scanner 110 would comprise a RFID reader (not shown) whose FOV 112 represents the acquisition area of the RFID reader.

The checkout scanner 110 communicates with a point-of-sale (POS) terminal 120 which receives the item identification information from the scanner. Typically, the POS terminal 120 takes the form of a programmed computer that interacts with various peripheral devices, as described hereinafter, to perform the function of a cash register. Using the item identification information, the POS terminal 120 interrogates a linked database 122 that contains item prices, such as the price of the item 111. Additionally, the database 122, hereinafter referred to as the “price database,” also provides a description or name of each item to provide human-readable information sufficient for a clerk operating the POS terminal 120 as well for a purchasing consumer, to confirm the correct scanning and proper pricing of the item 111. A register display 124 communicates with the POS terminal 120 to display the corresponding price and item description obtained from the price database 122. A receipt printer 126 in communication with the POS terminal 120 serves to print a receipt (not shown) identifying the items purchased and their respective prices.

As mentioned previously, the checkout scanner 110 can also read the bar code on a coupon (not shown) when presented by a consumer in connection with the purchase of the item 111. The barcode information read from the coupon by the checkout scanner 110 typically identifies the item to which the coupon applies, as well as the discount offered by the coupon. The POS terminal 120 processes the coupon information to determine whether the current transaction satisfies the terms of the coupon (e.g., the consumer has purchased the appropriate item). Upon finding the consumer has satisfied the terms of the coupon, the POS terminal 120 will fulfill the coupon offer, typically by applying the appropriate discount to the price of the associated item 111.

The prior art Point-Of-Sales (POS) system 100 of FIG. can include a second database 130, hereinafter referred to as “the post-sale offer database” because it contains post-sale offers (e.g., discount coupons, 2-for-1 certificates, and/or or other material such as advertisements and the like) for various items. Just as the POS terminal 120 queries the price database 122 for the price and description of the scanned item 111 to complete a purchase transaction, the POS terminal also queries the post-sale offer database 130 to determine if a post-sale offer exists for the scanned item. If so, the POS terminal 120 triggers a checkout coupon printer 132 to print a coupon, certificate and/or other material corresponding to the post-sale offer. The clerk operating the POS terminal 120 will provide the coupon, certificate and/or other material associated with the post-sale offer to the consumer at the completion of the purchase transaction. The post-sale offer need not relate to item scanned or a competing product. Indeed, the post-sale offer could apply to totally unrelated items or could contain general information.

In practice, the consumer receives the post-sale offer printed by the checkout coupon printer 132 at the completion of the purchase transaction. Thus, the post-sale offer will only influence future buying decisions, not the present buying decision. Moreover, to make use of the post-sale offer, the consumer must present the offer when purchasing corresponding item(s). Thus, the consumer must make an affirmative effort not only to save the post-sale offer but to present it at the time of a future purchase.

FIG. 2 depicts a block schematic diagram of a pre-sale offer system 150 for providing a consumer with one or more pre-sale offers to influence a present purchasing transaction in accordance with a preferred embodiment of the present principles. As described hereinafter, the pre-sale offer system 150 provides a consumer with a pre-sale offer in advance of an actual purchase resulting from the scanning of a selected item by the checkout scanner 110 of FIG. 1. As described hereinafter, the consumer can take advantage of the pre-sale offer as part of a present purchasing transaction, rather than wait for a future purchase transaction as in the case of a post-sale offer(s) by the POS system 100 of FIG. 1.

As depicted in FIG. 2, the pre-sale offer system 150 of FIG. 2 comprises a pre-sale item scanner 160 which can detect and identify each item 111 in advance of actual scanning by the checkout scanner 110 of FIG. 1. Like the checkout scanner 110 of FIG. 1, the pre-sale item scanner 160 of FIG. 2 typically comprises a bar code reader (not shown) which generates a beam 164 that sweeps the scanner's FOV 162 to read the item bar code 118 Alternatively, the pre-sale item scanner 160 can comprise an RFID reader for detecting an RFID tag (not shown) on the item 111 when item lies within range of the scanner's FOV 162.

The pre-sale item scanner 160 identifies the item 111 to a pre-sale offer engine 170. The pre-sale offer engine 170 typically takes the form of a programmed computer or the like having the ability to communicate with various peripheral devices to perform certain operations in connection with such devices as described hereinafter. For example, the pre-sale offer engine 170 communicates with a database 172, hereafter referred to as “the pre-sale offer database” which contains pre-sale offers for various items. Such a pre-sale offer can comprise an advertisement and/or other promotional material for a competing product which provides the opportunity for a manufacturer to tout the advantages of their brand. Such a pre-sale offer can comprise an incentive, such as a discount coupon or the like, to buy a competing item. For example, if the identified item 111 scanned by the scanner 160 of FIG. 2 comprises a bottle of hair shampoo from Manufacturer A, the offer database 160 could contain an pre-sale offer in the form of a discount coupon for hair shampoo from Manufacturer B, to entice the consumer to change her/her purchasing decision. To facilitate the acceptance of such offers, a store will preferably stock items subject to such offers nearby for easy access by consumers.

Alternatively, a pre-sale offer could comprise an advertisement and/or other promotional material, to reinforce the consumer's decision to buy the item already selected for purchase. A reinforcing advertisement could remind the consumer as to the particular motto associated with the product itself, or more generally to the motto directed to the manufacturer's general brand.

Also, the pre-sale offer could include an advertisement or other promotional material for one or more companion items, such as incremental ingredients that complete a recipe that includes the initially selected item. For example, a consumer could receive an offer for pancake mix in response to the pre-sale item scanner 160 detecting a bottle of pancake syrup. Further, the pre-sale offer could comprise a coupon and/or advertisement for an item suitable for an associated demographic (e.g., an advertisement for disposable diapers in response to detecting a jar of baby food).

By querying the pre-sale offer database 172, the pre-sale offer engine 170 can determine whether a pre-sale offer exists for the item 111 identified by the pre-sale sale item scanner 160. If a pre-sale offer exists, the pre-sale offer engine 170 can provide that offer to the consumer immediately in various ways. To the extent the pre-sale offer includes a multimedia presentation; the pre-sale offer engine 170 would present the visual portion of the pre-sale offer to the consumer on a pre-sale display 173. Accompanying audio would play over speakers (not shown). In place of, or in addition to, the multimedia presentation, the pre-sale offer engine 170 could provide information associated with the pre-sale offer for printing on a pre-sale offer printer 174. Alternatively, the pre-sale offer engine 170 could provide the pre-sale offer, in the form of a “virtual coupon” directly to the POS terminal 120 of FIG. 1 over a communications channel (not shown). In this way, the POS terminal 120 will behave in the same manner as if the checkout scanner 110 of FIG. 1 scanned a conventional discount coupon. Further, the pre-sale offer printer 174 could possess an ‘accept button’ (not shown) so that the printer only prints the pre-sale offer for consumers who are interested in accepting it, thereby saving paper.

In an implementation where the pre-sale offer engine 170 provides the POS terminal 120 of FIG. 1 with the pre-sale offer in the form of a “virtual coupon”, then the acceptance of the offer will occur automatically when the checkout scanner 110 of FIG. 1 scans the associated item. This approach takes advantage of the behavior of modern checkout systems which typically do not credit previously scanned coupons unless the checkout scanner 110 scans the corresponding item 111 sometime during the transaction.

Referring to FIG. 2, a pre-sale offer database server 180 initially populates and thereafter maintains the pre-sale offer database 172. The pre-sale offer database server 180 can reside locally for autonomous control over the pre-sale offer database 172. Preferably, the pre-sale offer database server 180 will reside at a remote location. Under such circumstances, the pre-sale offer database 172 remotely accesses the pre-sale offer database server 180, typically through a corporate network connection, such as a wide area network (WAN) or the Internet 182. Within a given retail location, the pre-sale offer database 172 can serve as a central entity which communicates by way of a wireless or a wired network connection to each instance of the pre-sale offer system 150. Alternatively, the pre-sale offer database 172 can be replicated to each instance of the pre-sale offer system 150.

Rather than provide a pre-sale offer immediately, the pre-sale offer engine 170 can queue the pre-sale offer according to a presentation prioritization scheme as better described with respect to FIG. 5. To better understand the manner in which the pre-sale offer engine 170 can prioritize pre-sale offers, consider the following example. A first item 111 enters the FOV 162 of the pre-sale item scanner 160 for identification. The pre-sale offer engine 170 queries the pre sale offer database 172 using the item identification obtained from the pre-sale item scanner 160. Assuming a pre-sale offer exists, the pre-sale offer database 172 returns the pre-sale offer. In this example, the pre-sale offer comprises an advertisement extolling the virtues of the brand to which identified item 111 corresponds.

However, the pre-sale offer database 172 can also provide information causing the pre-sale offer engine 170 to prioritize this first offer. Now assume a second item (not shown) enters the FOV 162 of the pre-item scanner 160 of FIG. 2 resulting in the return of a pre-sale offer from the pre-sale offer database 172 corresponding to this second item, thereby prompting the consumer to switch to a third item rather than purchase the second item. This second pre-sale offer can include information sufficient for the pre-sale offer engine 170 to afford this second offer a higher priority, and could possibly pre-empt the first pre-sale offer. Further, the second offer could also provide a coupon printed by pre-sale offer printer 174.

Preferably the pre-sale detection item area (not shown), encompassed by the FOV 162 of the pre-sale item scanner 160, does not overlap the checkout detection area (not shown) encompassed by the FOV 112 of the checkout scanner 110 of FIG. 1. Thus, at the time of identification of the item 111 by the pre-sale item scanner 160 of FIG. 2, the item has not yet become the subject of a purchase transaction in point-of-sale system 100 of FIG. 1. In other words, the item 111 has not yet undergone scanning by the checkout scanner 110. In this way, should a consumer elect to accept a pre-sale offer for another item and thereby decline purchasing the item 111; the consumer can remove or otherwise displace the item to avoid scanning by the checkout scanner 110 of FIG. 1. Once the checkout scanner 110 of FIG. 1 has identified the item 111, the item now becomes the subject of a purchase transaction in point-of-sale system 100. Thus, the item should no longer remain in the FOV 162 of the pre-sale item scanner 160 for detection by the pre-sale offer system 150 of FIG. 2

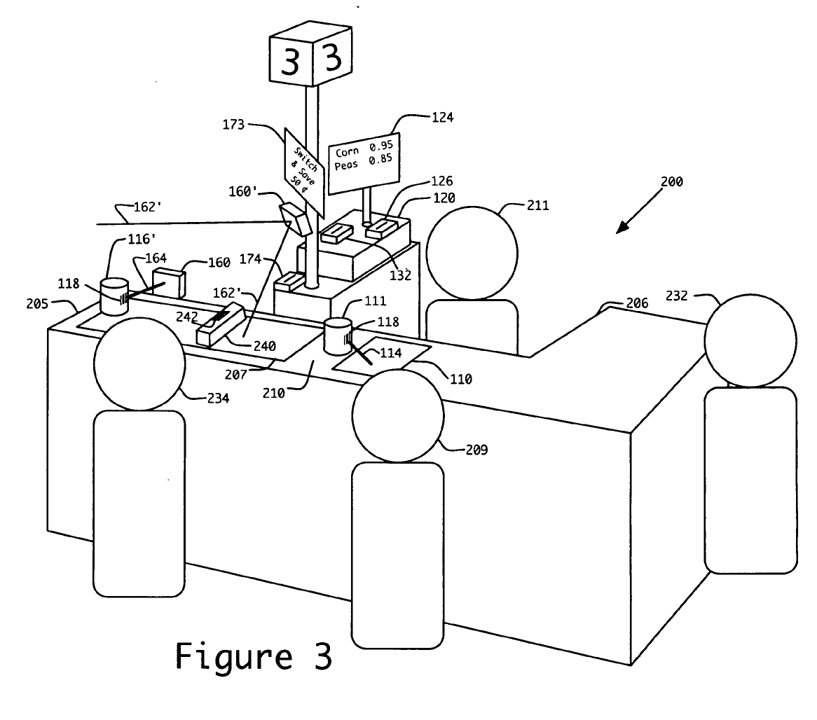

FIG. 3 illustrates a checkout station 200 in a typical supermarket that embodies the combination of the POS system 100 of FIG. 1 and the pre-sale offer system 150 of FIG. 2. To simplify understanding, like reference numerals appear in FIG. 3 to identify like elements that appear in FIGS. 1 and 2. The checkout station 200 typically comprises an “L”-shaped structure comprised of an elongated counter 205 connected to a loading area 206 lying at a right angle to the counter. A moving belt 207 extends partially along the counter 205 for receiving one or more items 111 deposited by a consumer 209 making a current purchase transaction. Thus, for ease of discussion, the consumer 209 will bear the designation “current consumer.” The belt 207 moves in a direction from left to right in FIG. 3 to transport the deposited item(s) 111 to a pre-scan area 210 so named because the area lies upstream of the checkout scanner 110. A clerk 211 operates the POS scanner 110 [[Bob: 120 is the POS Register]] by manually displacing each item in pre-scan area 210 past the checkout scanner 110 for scanning. After scanning each item 111, the clerk 211 places the item in the loading area 206 at which time a bagger 232 takes the item and places it in a bag or box for transport by the current consumer 209.

As previously described, the POS terminal 120 communicates with both the register display 124 and the receipt printer 126. As the clerk 211 displaces each item 111 past the checkout scanner 110, the register display 124 will display the identity of the item and its price. The register display 124 can provide either a single or multi-line display for viewing both by the clerk 211 and the current consumer 209. At the same the time, the register display 124 displays the identity and price of the item, the receipt printer 126 prints the corresponding information on a receipt (not shown). Further, the POS terminal 120 of FIG. 3 also communicates with the checkout coupon printer 132 to trigger the printer to print certificate(s), coupon(s) and/or other material associated with a post-sale offer as discussed previously.

Generally, the counter 205 of the checkout station 200 of FIG. 3 has a length sufficient to accommodate not only the current consumer 209, but another consumer 234 waiting to make a purchase transaction. For ease of the discussion, the consumer 234 bears the label “waiting consumer.” In practice, the display register 124 has an orientation that permits viewing by both the clerk 211 and the current consumer 209 when the current consumer stands directly opposite to, or just slightly to the right or left of the clerk. In contrast, the pre-sale display 173 has an orientation that permits viewing by the waiting consumer 234 who typically stands upstream of the current consumer 209. As viewed in FIG. 3, the waiting consumer 234 stands to the left of the current consumer 209. Preferably any audio accompanying display of a pre-sale offer on the pre-sale display 173 is directed to the waiting consumer 234 rather than the current consumer 209.

Since the checkout station 200 of FIG. 3 includes the pre-sale offer system 150 of FIG. 2, the checkout station 200 will include the pre-sale scanner 160. As depicted in FIG. 3, the pre-sale scanner 160 lies close to the upstream end of the belt 207 (i.e., the left-hand end of the belt in FIG. 3.) In this way, the pre-sale item scanner 160 can identify each item 111 initially selected for purchase before scanning by the checkout scanner 110 at which time the item typically becomes subject to a purchase transaction. Note that the pre-scale item scanner 160 need not necessarily identify each and every selected item 111. However, the more items 111 the pre-sale item scanner 160 can identify, the more effective the pre-sale offer system 150 of FIG. 2 will operate.

After identification of the item 111 by the pre-sale item scanner 160 and before scanning of the item by the checkout scanner 110, the pre-sale offer engine 170 of FIG. 2 will present available pre-sale offer(s) to the waiting consumer 234 via the pre-sale display 173. The waiting consumer 234 typically will accept such pre-sale offer(s) by pressing a button (not shown), located on the pre-sale offer printer 174 or on the pre-sale display 173 if equipped with a touch screen. The waiting consumer 234 could indicate acceptance by other methods as well. Upon acceptance of the pre-sale offer, or in the absence of any requirement for acceptance, the pre-sale offer printer 174 will print coupon(s), advertisements and/or other material associated with the pre-sale offer. Alternatively, the coupon(s) and/or other material associated with the now-accepted pre-sale offer could print on the checkout coupon printer 132 assuming the offer engine 170 of FIG. 2 enjoys a communication channel with POS terminal 120, thus obviating the need for the pre-sale offer printer 174 in the embodiment of FIG. 3.

Acceptance of a pre-sale offer also could occur upon the consumer identifying him or her to the pre-sale offer engine 170, for example by scanning an identification barcode or tag (not shown), assigned to the consumer. Many retailers currently make use of such barcodes to identify consumers who enroll in loyalty programs which allows tracking of consumer purchases. In exchange, such programs commonly provide discounts or other incentives. Typically, the barcode or tag appears on a keychain fob or on a plastic card carried by the consumer. By making use of the consumer's identification, the offer engine 170 of FIG. 2 can provide any pre-sale offer(s) through the consumer's cell phone, assuming access to such information, rather than printing the pre-sale offer on the pre-sale offer printer 174 or on the checkout coupon printer 132. In another variation of this embodiment, the pre-offer engine 170 of FIG. 2 could arrange for recording of the pre-sale offers made to consumers and could provide for their retrieval during a purchase transaction. Retrieval of the stored pre-sale offer(s) would occur after scanning of the consumer's identifying barcode by the checkout scanner 110 in order to associate the recorded pre-sale offers to the corresponding consumer.

To improve operation of the checkout station 200 of FIG. 3, one or more additional pre-sale item scanners 160′ could supplement the pre-sale item scanner 160. Each additional pre-sale item scanner 160′, with its respective its FOV 162′ could provide an additional vantage point to increase the likelihood of identifying the selected items 111. Rather than employ multiple pre-sale item scanners, the checkout station 200 could employ a single pre-sale item scanner 160′ mounted at a relatively high elevation so that the scanner's FOV 162′ covers an area substantially commensurate with the area occupied by the exposed surface of the belt 207.

Locating the pre-sale scanner 160′ at an elevation well above the belt 207 as illustrated in FIG. 3 to provide an increased FOV 162′ affords an improved situational awareness. In many instances, the waiting consumer 234 will place his/her selected items on the belt 207 upstream of those placed on the belt by the current consumer 209, A separator 240 serves to separate the items placed by the current consumer 209 from those placed by the waiting consumer 234. Typically, separator 240 takes the form of a plastic or wooden bar. In accordance with the present principles, the separator 240 carries indicia 242 in the form of a tag or barcode having a characteristic to permit its identification by the-sale offer engine 170 of FIG. 2 via the pre-sale item scanner 160′ of FIG. 3.

Depending on it sophistication, the pre-sale item scanner 160′ could not only identify the presence of the separator 240 but the location of the separator within the scanner's FOV 162′ as well. By identifying the presence and location of the separator 240, the pre-sale offer engine 170 of FIG. 2 can effectively separate those items selected by, and associated with the waiting consumer 234, from those items selected by, and associated with the present consumer 209. In this way, the pre-sale offer engine 170 can know which items have entered into a purchase transaction, thus making such items a potentially inconvenient target for a substitution offer. On the other hand, if the pre-sale item scanner 160′ observes that an item 111 lies upstream of the separator 240 (e.g., to the left of the separator in FIG. 3), the pre-sale offer system 170 of FIG. 2 can presume such an item belongs to the waiting consumer 234. As long as such an item has not left the FOV 162′ of the pre-sale item scanner 160′, ample opportunity exists for the waiting consumer 234 to make an exchange after accepting the pre-sale offer corresponding to the detected item 111.

Under the circumstance where the checkout station 200 of FIG. 3 employs a single pre-sale item scanner 160 mounted on the counter 205 at the upstream end of the belt 207, an item scanned by that scanner typically remains eligible as a target for a pre-sale offer for a predetermined interval following scanning. To account for starting and stopping of the belt 207 during a typical purchase transaction involving multiple items, the predetermined offer eligibility interval would undergo a comparison to the accumulated belt runtime to yield a comparison time value governing the period for pre-sale offer eligibility. Using the comparison time value would allow more time for making offers. The comparison time value accounts for intervals when the belt 207 remains stationary for a period of time, such as while current consumer 209 concludes the current transaction or in a case where the POS clerk 211 must fulfill the role of the bagger 232.

In connection with pre-sale offer(s) made to the waiting consumer 234, such as by way of the pre-sale display 173 and/or the by pre-sale offer printer 174, the retailer should provide an inventory of the items subject to such offer(s) at a location nearby the checkout station 200. In most stores, the checkout stand resides near the front of the store. Thus, providing in-front-of-store shelving would constitute an advantageous location for such an inventory so that the bagger 232 would have convenient access to item(s) subject to pre-sale offer(s) made available in accordance with the present principles.

Note that the pre-sale item scanner 160 and/or pre-sale item scanner 160′ need not reside at the checkout counter 200 of FIG. 3, but could easily reside elsewhere without any detrimental effect on the operation of the pre-sale offer system 150 of FIG. 2. Indeed, the same remains true for the pre-sale display 173 and pre-sale offer printer 174 because they too can reside at a number of locations throughout a store. In fact, a consumer more likely would act on a pre-sale offer when presented at the same time the consumer views a display of items corresponding to that offer. For example, the pre-sale item scanner 160 could reside on a shopping cart (not shown). Under such circumstances, the pre-sale item scanner 160 would comprise part of a distributed pre-sale offer system 150 whose remote elements communicate through wireless links through wireless communication. Alternatively, each shopping cart could carry a-self contained pre-sale offer system 150. A shopping cart implementation provides a particularly good candidate for reading a consumer's identity barcode or tag and subsequently providing pre-sale offers in electronic form either to the consumer's cell phone, or to the consumer's account for access during checkout.

As an alternative to the need for the pre-sale item scanners 160 and/or 160′ to reside at the checkout station 200 of FIG. 3, the pre-offer system 150 of FIG. 2 and the POS system 100 of FIG. 1 could communicate with each to share the checkout scanner 110 in the following manner. For example, when the item 111 enters a pre-sale detection area (corresponding to the FOV 162′ of the pre-sale item scanner 160′), the item will stimulate a pre-sale offer until such time as point-of sale system 100 of FIG. 1 enters the item as part of a purchasing transaction. Upon detecting the item 111, the checkout scanner 110 would signal the POS terminal 120 which, in turn would inform the pre-sale offer engine 170 of FIG. 2, thereby triggering a pre-sale offer if one exists. The POS terminal 120 would not automatically enter the item 111 as part of a purchase transaction at this time. Rather the POS terminal 120 would await some type of manual input, either from the clerk 211 operating the terminal, or from the current consumer 209 regarding the consumer's decision to buy the identified item 111 in light of the pre-sale offer. In other words, the POS terminal 120 would “buffer” the scanning of the items for purchase.

Assuming the current consumer 209 declines the offer and accepts the initially selected item 111, the consumer will signal such acceptance, either directly or indirectly to the POS terminal 120. Accordingly, the POS terminal 120 of FIG. 1 enters the item 111 as part of the purchase transaction. Upon entering the item 111 as part of the purchasing transaction, the POS terminal 120 provides notice to the pre-sale offer engine 170 to drop the item from a list that might stimulate certain pre-sale offers. Each new item entering the pre-sale area causes the above process to repeat itself. Rather than wait to enter the item 111 until the consumer declines the pre-sale offer, the POS terminal 120 could enter the item 111 immediately after scanning but thereafter remove the item should the consumer elect to accept a pre-sale offer associated with a competing product. A single scanner system remains more suitable for small transactions or low transaction rate situations, for example convenience stores.

In still another embodiment, the checkout station 200 could employ a single scanner having a wide FOV subdivided into multiple zones. The first zone would serve as the equivalent of the FOV 162 of the pre-sale item scanner 160 and the second zone would serve as the equivalent of the FOV 112 of the checkout scanner 110.

Some retail locations now include one or more self-checkout stands which allow the current consumer 209 to also perform the role of the clerk 211. Such a self-checkout stand could embody the pre-sale offer system 150 of FIG. 2 in the manner described with respect to the checkout station 200 of FIG. 3. In such a configuration, the pre-sale display 173 would directly face current consumer 209. Otherwise, the system would operate in the same manner as the checkout stand of FIG. 3.

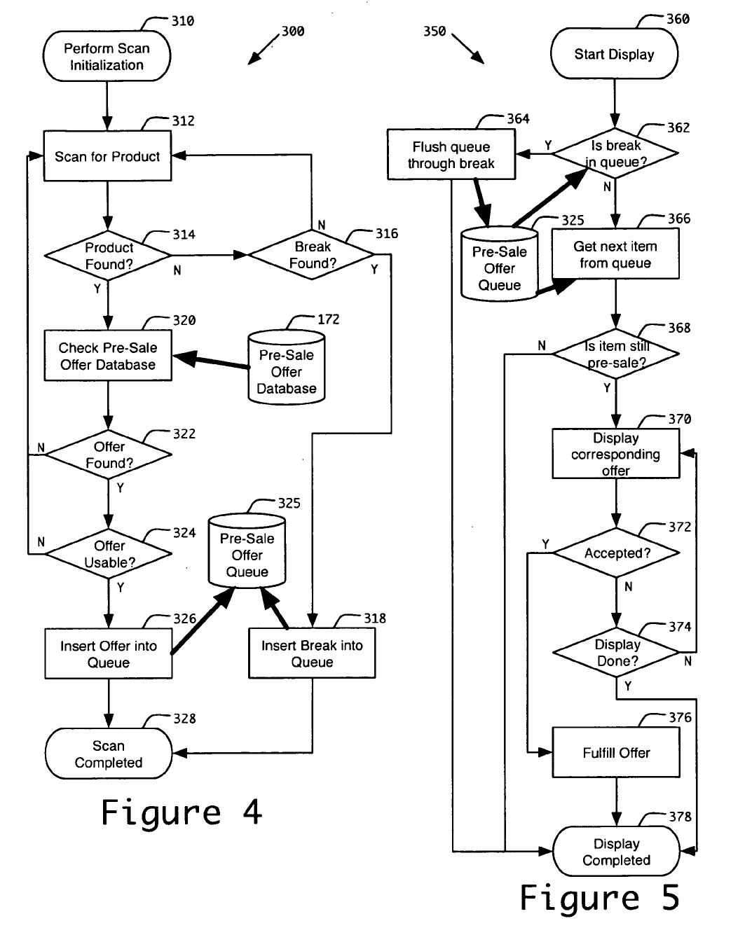

FIG. 4 depicts a flowchart of a process 300 practiced by pre-sale offer engine 170 of the pre-sale offer system 150 of FIG. 2 for detecting the item 111 of FIGS. 2-3 and for checking the existence of pre-sale offer(s) associated with that item. The pre-sale offers identified by the process 300 of FIG. 4 undergo presentation by a process practiced by the pre-sale offer engine 170 in the manner described hereinafter with respect to FIG. 5. The item detection process 300 of FIG. 4 begins with step 310, at which time the pre-sale item scanner(s) 160 and/or 160′ of FIG. 3 undergo initialization, as well as calibration as necessary. Actual scanning occurs upon execution of step 312 during which the pre-sale item scanner 160 and/or 160′ sweep their respective FOVs to identify the bar code 118 or other such identifier on the item 111 of FIGS. 2 and 3.

During step 314 of FIG. 4, the pre-sale offer engine 170 of FIG. 2 determines whether the item identification provided by the pre-item scanner 160 and/or 160′ of FIG. 3 corresponds to a valid item. A valid item constitutes an item whose bar code 118 of FIGS. 1-3 takes the form of a well known a Universal Item Code (UPC) barcode or whose RFID takes the form of a standard item RFID. Upon identifying a valid item, processing continues at step 320. Otherwise, if the identifier does not match a valid item, then processing continues at step 316.

Upon detecting a valid item during step 314 of FIG. 4, the pre-sale offer engine 170 queries the pre-sale offer database 172 of FIG. 2 during step 320 to check whether any pre-sale offer exists for the identified item or the category or categories to which item belongs, depending upon the arrangement of the pre-sale offer database 172 and what rules govern correspondence. Following the query made during step 320, the pre-sale offer database 172 will return such pre-sale offer(s) if any to the offer engine 170. Thus, the pre-sale offer database 172 could return no pre-sale offers, or one or more such offers.

As discussed previously, a pre-sale offer returned to the pre-sale offer engine 170 can take the form of a discount coupon or other type of incentive to purchase a competing product. The pre-sale offer can also seek to encourage the consumer to purchase one or more related or companion items. Pre-sale offers for related products typically depend on a “recipe.” Such a recipe comprise a recipe in the literal sense, i.e., a list of components mixed together for cooking purposes, Thus, a consumer's selection of flour and eggs would suggest the desirability of providing one or more pre-sale offers for related items such as sugar or icing, on the presumption that the selected items comprise ingredients in a baking recipe. Alternatively, the recipe could comprise a predefined relationship among certain items for shopping purposes. To illustrate the latter case, a consumer's selection of items corresponding to a holiday dinner, e.g., a turkey and a box of mashed potato flakes, would suggest the suitability of a pre-sale offers for other items in a ‘holiday dinner recipe’, such as pumpkin pie and cranberry sauce. The use of a recipe provides a powerful mechanism for broadening the number of pre-sale offers based on the identity of the items detected for purchase by the consumer.

If no pre-sale offers correspond to the identified item during step 322, program execution returns to step 312 to scan for an addition item. Otherwise, step 324 follows step 322 and a check then occurs whether the pre-sale offer found during step 324 remains usable. Several circumstances can exist which render a pre-sale offer unusable. For example, if the pre-sale offer duplicates an offer previously rejected by a consumer for the same item, little if any benefit exists in presenting the same pre-sale offer again. Other reasons for rejecting a pre-sale offer would also include expiry of the offer or over exposure (e.g., presentation of the pre-sale offer too often). Another reason for rejecting a pre-sale offer would include substantial depletion of inventory of available items corresponding to the offer(s) stored on the in-front-of store shelving. If no pre-sale offers ads remain following step 324, then the process returns to step 312.

Any pre-sale offer(s) remaining after step 324 enter a pre-sale offer queue 325 during step 326 for further processing in accordance with the process 350 of FIG. 5. Those skilled in the art will recognize that ‘inserting the pre-sale offer into a queue’ is easily achieved by adding a reference to the pre-sale offer (e.g., an offer number or an offer name) or for example, a record ID in the pre-sale offer database 172, into the pre-sale offer queue 325 or other storage mechanism. As will be become better understood hereinafter, providing such a reference in the pre-sale offer queue 325 provides the offer presentation process 350 the ability to access any metadata or media associated with, or apropos to, the pre-sale offer. Also at step 326, the setting of a counter or flag can occur upon the return of a pre-sale offer. Such flags or counters will undergo subsequent examination upon the next execution of step 324 to evaluate the appropriateness of placing a particular pre-sale offer into the pre-sale offer queue 325 upon future iterations of the process 300. Following queuing of pre-sale offers during step 326, the process of identifying pre-sale offer(s) for a single item ends during step 328. Preferably, this process for searching for pre-sales offers continues indefinitely by re-executing process 300 repeatedly so long as the checkout station 200 of FIG. 3 remains active.

Execution of the process 300 as described thus far presumed detection of a valid item during step 314. In the case where the identifier detected by the pre-sale item scanner 160 and/or 160′ of FIG. 3 does not represent a valid item, execution of step 316 occurs at which time the pre-sale offer engine 170 of FIG. 2 tries to match the identifier of the separator 240 of FIG. 3 against the identifier detected by the pre-sale item scanner. Upon finding no match, program execution returns to step 312. Should the pre-sale item scanner 160 and/or 160′ of FIG. 3 detect the separator 240, then step 318 undergoes execution to insert a break into the pre-sale offer queue. This break identifies the boundary between the items selected by the present consumer 209 of FIG. 3 and thus serves to separate or trigger a summary of the pre-sale offers made to the waiting consumer 234 during the pre-sale offer presentation process 350 of FIG. 5. The insertion of a break into the pre-sale offer queue at step 318 also can constitute an opportunity to clear any counters maintained at step 326 to prevent a given pre-sale offer from occurring too frequently or from being added repeatedly to the pre-sale offer queue 325 for the same consumer.

FIG. 5 depicts a flow chart of the process 350 mentioned earlier for presenting pre-sale offers established during the process 300 of FIG. 4 to a consumer to influence a present purchasing decision. This separation of the process for establishing the existence of a pre-sale offer and the process for presenting such an offer to a consumer by no means constitutes an essential requirement for operation of the pre-sale offer system 150 of FIG. 2. Indeed, the process 350 of FIG. 5 for presenting pre-sale offers can operate in parallel with item detection process 300. Separation of the process simply enables greater clarity of explanation. Those skilled in the art will recognize from the following description the possibly of many alternative implementations.

The process 350 of FIG. 5 for presenting pre-sale offers commences upon execution of step 360 at which time the pre-sale display 173 of FIGS. 2 and 3 undergoes initialization which can include setting the display to an appropriate format, identifying a subpicture, crossfading from the previous presentation (either image or audio), or any activity that accounts for the current status of pre-sale display and prepares it to make a subsequent presentation. Such preparation can include waiting for a previous presentation to substantially finish playout. Step 362 follows step 360 at which time, the pre-sale offer engine 170 queries the pre-sale offer queue 325 to determine whether a break exists, corresponding to the detection of the separator 240 of FIG. 3. If so, step 364 undergoes execution to flush the pre-sale offer queue 325 up to and including the break representing separator 240. Flushing the pre-sale offer queue 325 provides a mechanism to ensure that the pre-sale offers pertinent to those items 111 of FIG. 3 selected by current consumer 209 do not undergo delivery to the waiting consumer 234 of FIG. 3. Instead, the process 350 proceeds substantially directly to provide pre-sale offers correlated to items belonging to the waiting consumer 234. If such a flush is appropriate, the changes are made to the pre-sale offer queue 325. Thereafter, step 378 occurs at which time the current iteration of process 350 becomes complete and can begin again.

Upon finding no break during step 362 (and hence no need to flush the pre-sale offer queue 325 during step 364), then execution of step 366 occurs, triggering retrieval of the pre-sale offer in the pre-sale offer queue 325. For the process 350 FIG. 5, the pre-sale offer queue can operate as a default first-in, first-out (FIFO) queue. This affords the benefit of simplicity because pre-sale offer(s) associated with identified item will play out (barring an adverse decision in previously executed step 362 or subsequently executed step 368 described hereinafter) in substantially the order items on the belt 205 of FIG. 3 underwent scanning by one or more of the pre-sale item scanners 160 and/or 160′.

Preferably, however, selection of the next pre-sale offer retrieved from the pre-sale offer queue 325 occurs on the basis of a prioritization scheme applied to each offer retrieved from the queue. The prioritization can remain static and the pre-sale offer database 172 of FIG. 2 can store information describing such a static prioritization scheme. Alternatively, the prioritization can change dynamically based on the accumulation of identified items of a given consumer (or sequence of consumers as discussed below). Also, the prioritization can change dynamically based on parameters stored in pre-sale offer database 172, or a combination of any of these factors.

Factors the influence the prioritization can include data about the pre-sale offer itself, including its duration, (e.g., the dates of validity). For example, when considering the revenue amounts for presenting an individual pre-sale offer, a utility function can take revenue per second into account. In another example, a store might advertise turkeys before Thanksgiving, but with an especially high value in the days immediately before the holiday, and (with the exception of a sale), a lower priority value after the holiday.

The prioritization of pre-sale offers can take into account many factors. Those pre-sale offers corresponding to items lying beyond the next break (i.e., the next location of the separator 240 of FIG. 3) can be substantially ignored, or devalued in the prioritization. Those pre-sale offers for which offer to pay the retailer a higher fee, or which correspond to a predetermined contractual obligation, can receive a higher value in the prioritization scheme. Those pre-sale offers which are duplicative with the waiting consumer 234 (for whom the pre-sale offers are playing) and the current consumer 209 (whose pre-sale offers can have been seen by current consumer 234) can be devalued.

The pre-sale offer system 150 can place pre-sale offers in direct competition with each other, by bidding for higher valuation in the prioritization either for individual placements or for a broader, potentially exclusive arrangement. Such bidding can occur monthly, weekly, or even in real-time, using an online auction interface (not shown) for pre-sale offer database 172. This service can be provided by the pre-sale offer database server 180 and can be accessed through the corporate WAN or Internet 182. The pre-sale offer database server 180 would enable remote creation and editing of prioritization parameters (e.g., revenue-per-play) stored in pre-sale offer database 172. The user interface (not shown) can be driven by the pre-sale offer database server 180 and thus can further execute a pre-sale offer-buy transaction wherein an advertiser is able to purchase exposure on pre-sale offer system 150. Those skilled in the art will recognize that server 180, especially in a financial transaction mode, will require appropriate security precautions and that appropriate architectural considerations (e.g., n-tier organization) would apply. Such architectural considerations can apply without deviating from the spirit of this description as they have been minimized for clarity.

The offer prioritization preferably takes the form of a utility function intended to optimize the retailer's and/or advertisers' revenue, without making the pre-sale offer system 150 seem obtrusive. In this way, the highest priority (i.e., highest utility, or highest value) pre-sale offer(s) the in pre-sale offer queue 325 would be presented to waiting consumer 234. It is expected that the result will be heavily weighted to the items selected by the waiting consumer 234, but in cases of extremely high priority values, items from other consumers (e.g., the current consumer 209, or the consumer (not shown) after the waiting consumer 234 can be associated with the selected pitch. In the case of a selection related to items of current consumer 209, such a high value represents a strong desire of an advertiser to present such a pre-sale offer to a consumer, even if only in a last moment situation. In the case of a selection related to items of the consumer after waiting consumer 234, the high value can represent an effort to provide the target consumer some extra time to evaluate the offer or advertisement, perhaps to provide an extra opportunity to make a swap. The pre-sale offer system 150 can also provide for a difference in prioritization of items detected before separator 240 or after a next separator (not shown) corresponding to these different consumers.

Further, the prioritization of a pre-sale offer associated with a particular item can change due to the identification of an additional item. For instance, upon detecting a particular product, say ajar of peanut butter from Manufacturer A, the pre-sale offer engine 170 of FIG. 2 could enter a corresponding reinforcing type pre-sale offer for that item into pre-sale offer queue 325. However, when determining the priority of that pre-sale offer in step 366, the queued pre-sale offer could achieve a higher priority if an immediately prior or immediately subsequent consumer selects a different brand of peanut butter. Similarly, an pre-sale offer promoting items in a particular category for a give manufacturer, say a manufacturer of jams and preserves, could receive a high priority when both the peanut butter of and another brand of jam appears rather than if the peanut butter appears alone.

Still more factors can influence the prioritization of the pre-sale offers. A particular item corresponding to a pre-sale offer listed in pre-sale offer database 172 can have a positive or negative association with a particular demographic. For instance, the identification of baby diapers among the items selected by a consumer would suggest a young family demographic, which can de-prioritize pre-sale offers for products more associated with a mature family, for example denture cream. However, the presence of adult diapers might suggest an aging demographic, and would have the opposite effect, instead prioritizing pre-sale offers for items associated with such a demographic, such as denture cream.

Although the offer selection that occurs step 366 typically make use of a utility function and/or certain prioritization factors, the selection of pre-sale offers by could occur other methods (in addition to, or in place of a simple FIFO), as exist in the art. Other methods could include rules-based and/or a quota-based approaches.

Upon retrieval of the next pre-sale offer from pre-sale offer queue 325 of FIG. 3, a test occurs during step 368. If the pre-sale offer corresponds to an identified item already part of a purchase transaction, then the pre-sale offer system 150 can forgo presenting the pre-sale offer. Detecting that an identified item has already entered a purchase transaction can occur simply by having the POS sales system 100 of FIG. 1 communicate the identification of each scanned item to the pre-sale offer system 150 of FIG. 2. Preferably, the immediacy of a transaction depends on the amount of time that elapsed since the identified item was last seen by one of the pre-sale item scanners 160 and/or 160′ of FIG. 3. This amount of time can take into account the running of belt 207. For example, an identified item might be considered to have ‘gone to a purchase transaction’ if belt 207 has run for a sufficient time to carry the identified item from the last location where it could have been detected by one of the pre-item scanners 160 and/or 160′ to the pre-scan area 210 of FIG. 3, less a certain fixed time, e.g., five seconds. In this way, a pre-sale offer can be selected with a reasonable confidence that the waiting consumer 234 has time to react without interrupting or reversing a transaction concerning that item.

If, during step 368, the pre-sale offer engine 170 of FIG. 2 detects a purchase transaction or presumes such a transaction is sufficiently imminent, the pre-sale offer engine will forego the presentation of the prioritized pre-sale offer and proceed to step 378, thereby completing the offer presentation process. Otherwise, processing continues at step 370 during which time, the pre-sale offer engine 170 will fetch the next pre-sale offer for presentation on the pre-sale display 173 for primary viewing by the waiting consumer 234. If the pre-sale offer undergoing presentation requires acceptance by the waiting consumer 234, then execution of step 372 occurs, whereupon the pre-sale offer engine 170 of FIG. 2 monitors for an acceptance by the waiting consumer 234, such as the actuation of a button (not shown) on pre-sale offer printer 174 or by the actuation of a touch screen associated with the pre-sale display 173. Upon detecting acceptance by the waiting consumer 234, processing continues to step 376 at which time fulfillment of the offer occurs, followed by execution of step 378 as described previously.

If no acceptance has occurred or is found necessary during step 372, then processing proceeds to step 374 whereupon the process 350 loops back, continuing to present the pre-sale offer during step 370 until the pre-sale offer has run out or an acceptance has occurred during step 372. If the pre-sale offer substantially concludes without an acceptance, the presentation process 350 ends for the present pre-sale offer at step 378 for subsequent execution to ready the next pre-sale offer.

During the pre-sale offer fulfillment step 376, the waiting consumer 234 receives the pre-sale offer and has indicated an acceptance. When this occurs, the pre-sale offer printer 174 can print the pre-sale offer or the pre-sale offer engine 170 can communicate the offer to the POS terminal 120 of FIGS. 1 and 3. In an alternative embodiment, or for correspondingly marked pre-sale offers in pre-sale offer database 172, acceptance is presumed and the pre-sale offer printer 174 will print the offer automatically, even without explicit acceptance by the waiting consumer 234 during step 372.

In the case where an acceptance of a pre-sale offer requires fulfillment from a stock of items kept in proximity to the pre-sale display 173 or the checkout counter 200, then each acceptance of an offer can reduce the expected stock. The pre-sale offer engine 170 can monitor such dwindling stock and can trigger an alert to induce a clerk to restock the inventory. The dwindling stock can serve as a negative bias making presentation of pre-sale offers for that item less desirable so that the presentation of further pre-sale offers ends as the supply at hand runs out.

As discussed above, in the illustrative embodiment, the checking of the pre-sale offer database 172 during step 320 and the associated gathering of the pre-sale offers into the pre-sale offer queue 325 at step 326 of FIG. 4 occurs separately from the pre-sale offer prioritization during step 366 of FIG. 5. This separation between the gathering of pre-sale offers and their prioritization does not constitute a limitation of the present principles, but merely a one of many functional embodiments. Indeed, offer prioritization easily could occur in connection with step 326.

In yet another embodiment of the present principles, the pre-sale offer engine 170 of FIG. 2 simply could gather all items identified by one of the pre-sale item scanners 160 and/or 160′ into an item queue (not shown) in lieu of pre-sale offer queue 325. No pre-sale offer selection would occur during the process 300. Instead, during step 366 the list of items seen so far in the item queue for the waiting consumer 234 could undergo analysis as demographic indicators. The resulting accumulated demographic estimate (as described above in the diapers examples) can serve as the basis for select pre-sale offers having the highest priority.

The foregoing describes a technique for providing a consumer with one or more pre-sale offers in advance of a purchase transaction to influence a buying decision.

1. A method comprising the steps of:
(a) identifying at least one item selected prior to purchase; and
(c) providing a pre-sale offer for the at least one identified item prior to purchase.

2. The method according to claim 1 wherein the step of providing the pre-sale offer further comprises the step of providing a discount coupon for a competing item.

3. The method according to claim 1 wherein the step of providing the pre-sale offer further comprises the step of providing a discount coupon which applies to a related item.

4. The method according to claim 4 wherein the step of providing a discount coupon which applies to a related item further comprises the step of identifying the related item in accordance with the at least one identified item using a prescribed recipe.

5. The method according to claim 1 wherein the step of providing the pre-sale offer further comprises the step of providing a message to reinforce a decision to purchase the selected item.

6. The method according to claim 1 wherein the step of providing the pre-sale offer further comprises the step of providing a multimedia presentation descriptive of the pre-sale offer.

7. The method according to claim 2 the step of providing the discount coupon further comprises the step of printing the coupon.

8. The method according to claim 1 wherein the step of providing the pre-sale further comprises the step of querying a database containing pre-sale offers to check whether a pre-sale offer exists for the at least one identified item.

9. A method comprising the steps of:
(a) identifying each of a plurality of items selected time prior to purchase;
(b) checking whether a pre-sale offer exists for each identified item; and if more than one pre-sale offer exists, then
(c) prioritizing the pre-sale offers for presentation to influence purchasing of at least one item.

10. The method according to claim 9 wherein the prioritizing step further comprises the step of prioritizing the pre-sale offers in accordance with a static prioritization scheme.

11. The method according to claim 9 wherein the prioritizing step further comprises the step of dynamically prioritizing the pre-sale offers.

12. The method according to claim 11 wherein the pre-sale offers are dynamically prioritized in accordance with an accumulation of identified items of a given consumer.

13. The method according to claim 11 wherein the pre-sale offers are dynamically prioritized in accordance with at least one stored parameter.

14. The method according to claim 9 wherein the pre-sale offers are prioritized to optimize revenue.

15. The method according to claim 9 wherein the pre-sale offers are prioritized using at least one of a utility function, a rules-based approach or a quota scheme.

16. The method according to claim 9 wherein the checking step comprises the step of querying a database containing pre-sale offers to check whether a pre-sale offer exists for each identified item.

17. Apparatus comprising:
(a) at least one scanner for identifying at least one item selected prior to purchase; and
(b) first means responsive to identification of the product for determining if at least one pre-sale offer exists; and
(c) second means for presenting the at least one pre-sale offer to a consumer to influence a purchasing decision.

18. The Apparatus according to claim 17 wherein the pre-sale offer comprises a discount coupon for a competing item.

19. The apparatus according to claim 17 wherein the pre-sale offer comprises a discount coupon for a related item.

20. The apparatus according to claim 17 wherein the pre-sale offer comprises a message to reinforce a decision to purchase the selected item.

21. The apparatus according to claim 17 wherein the second means further comprises a visual display.

22. The apparatus according to claim 17 wherein the second means further comprises a printer.

23. Apparatus comprising:
(a) at least one scanner for identifying each of a plurality of items selected time prior to purchase;
(b) first means responsive to identification of the item by the scanner for checking whether a pre-sale offer exists for each identified item; and
(c) second means prioritizing the pre-sale offers; and
(d) third means for presenting the prioritized pre-sale offers to influence purchasing of at least one item.
